(19) United States
(12) Patent Application Publication
(10) Pub. No.: US 2008/0230619 A1
(43) Pub. Date: Sep. 25, 2008

(54) Heating or heating and air conditioning unit with noise abatement feature and method of use

(76) Inventor: Robert Kirby, Sparta, TN (US)

Correspondence Address: CLARK & BRODY, 1090 VERMONT AVENUE, NW, SUITE 250, WASHINGTON, DC, 20005, US

(21) Appl. No.: 12/076,180

(22) Filed: Mar. 14, 2008

Related U.S. Application Data
(60) Provisional application No. 60/907,117, filed on Mar. 21, 2007.

(51) Int. Cl. H05B 3/06

(52) U.S. Cl. 237/81; 219/532

(57) ABSTRACT

A heater for a heating or heating and air conditioning unit employs a screen positioned between a heater and a fan of the unit. The screen disrupts air flowing from or to the heater to reduce noise generated by the unit when the heater is energized. The screen partially disrupts the air flow between the heater and the fan.

This application claims priority under 35 USC 119(e) based on provisional patent application No. 60/907,117, filed on Mar. 21, 2007, which is incorporated herein by reference.

### TECHNICAL FIELD

The present invention relates to heating or heating and air conditioning units and in particular to the use of a screen in connection with the heater of the unit for noise abatement when the unit is being operated in the heating mode.

### BACKGROUND ART

The use of electric heaters for comfort heating is well known in the industry. Heaters may be of the open coil type or of the tubular, or enclosed, type. Examples of open coil heater art are demonstrated in U.S. Pat. No. 6,443,318, No. 6,509,554, No. 6,593,554, No. 6,600,141, No. 6,624,398, and No. 6,723,968. Examples of enclosed tubular heats for comfort heating may be found in products produced by Industrial Engineering & Equipment Co. and by Brasch Manufacturing Company, Inc.

One significant aspect of the use of electric heaters is that of mounting heaters inside equipment that delivers air by means of fans or blowers. One type of equipment for this purpose is often referred to as a “room air conditioner” meaning a single piece of equipment either located within the living space being conditioned, located in the wall of the living space or installed through a window of a room. Essentially, these units may provide hot and cold air according to the preference of a user. Another type of equipment could be just a heating unit that uses a heater and blower or fan. These types of equipment are normally referred to as space heaters, packaged terminal air conditioners and window air conditioners. The equipment delivers air directly into the living space or room. In some cases, the equipment is configured as to condition air in more than one room using a very simple duct system or by the design of the adjacent spaces to permit air movement between them. Some examples of applications are homes, hotels, motels, assisted living facilities, rest homes, colleges and other such institutional or commercial establishments.

A further feature is that the equipment's fan or blower draws or pulls air from the space being conditioned and the equipment appropriately conditions the air and directly exhausts this conditioned air back into the room. Depending upon the configuration of the equipment, it is common to locate an electric heater either on the inlet side or on the exhaust side of the equipment blower or fan. Alternatively, air may be brought in from outside the room or area.

A feature of fans and blowers is that, upon operation, air movement and vortexes created by the air movement can create vibrations of the rotational parts of the system. Moreover, the air itself creates disturbances as it moves through the system. The level of the vibrations or disturbances may change during those times when the heater operates. The changes result either from the expansion of the heated air, vortexes created by the moving air or that the heat generated by the electric heater affects surrounding components of the system. Any or all of these disturbances can rise to an audible level that may be detected by occupants of the room.

People likely to hear the disturbances created by “room air conditioners” are occupants of hotels, motels, occupants of offices, residents of institutions, occupants of commercial establishments such as offices, etc. Sounds emanate from within the unit, whether it is a heating unit or a heating and air conditioning unit, and these sounds are problematic since they disturb the occupant.

### SUMMARY OF THE INVENTION

The present invention overcomes the objectionable noise emanating from units that include a heater and fan for heating a particular space. Typically, the unit is configured with the fan and heater in close proximity such that the heated air passing into the fan or forced air driven into the heater can cause the unit to generate an audible hum or noise.

While the unit could be just the combination of a heater and a fan, it could also be the combination of a heater, fan and air conditioning apparatus, which would include evaporator coils in line with the heater for treatment of air. The air conditioning units could be room air conditioners, which could be mounted or configured in any number of ways to heat the desired space. A particular air conditioning unit adapted for the invention is a packaged terminal air conditioner (PTAC). In most instances, the heater is upstream of the fan, but in certain applications, it is possible that the fan would be upstream of the heater, and the proximity of the two in this arrangement could still generate the objectionable audible hum.

To remove the audible hum that is generated when the heater is operated in these types of units, a screen is positioned between the heater and the fan. It is believed that the screen disrupts the air flow between the heater and fan so that any noise generated as a result of the heater operation is reduced to below an audible level or eliminated. Thus, someone in a room or location being serviced by the unit does not experience any annoying noise. The screen positioning can vary depending on the physical arrangement of the heater and fan. In PTAC units, noise abatement can occur by covering a portion of the area of the heater that has air passing over the heater coils for heating purposes.

Thus, according to the embodiments, an open coil electrical resistance heater is disclosed. The heater includes a frame. The heater also includes at least one electrical resistance wire coil. The heater also includes a plurality of insulators connecting the at least one electrical resistance wire coil to the frame. The plurality of insulators and at least one electrical resistance wire coil form an air flow area to expel air from the heater. The heater also includes at least one screen positioned adjacent the at least one electrical resistance wire coil to cover the air flow area.

Further according to the embodiments of the present invention, a method of using a heating unit or a heating and air conditioning unit is disclosed. The method includes drawing air through an open coil electrical resistance heater by a fan. The open coil electrical resistance heater includes at least one electrical resistance wire coil supported on a frame by insulators. The method also includes energizing the heater to heat the air. The method also includes partially disrupting the air from the heater with at least one screen positioned between the fan and the at least one electrical resistance wire coil.

Further according to the embodiments of the present invention, a heater unit or a heating and air conditioning unit also is disclosed. The unit includes an open coil electrical resistance heater, wherein the heater has a frame. The unit also includes at least one electrical resistance wire coil. The unit also includes a plurality of insulators connecting the at least one resistance wire coil to the frame. The insulators and the at least one electrical resistance wire coil form an air flow area to expel air from the heater for heating a space. The unit includes at least one screen positioned adjacent the at least one electrical resistance wire coil to cover the air flow area.

### BRIEF DESCRIPTION OF THE DRAWINGS

The accompanying drawings illustrate embodiments of the present invention and are included to provide further understanding of the invention. The drawings constitute a part of this specification. Together with the description, the figures listed below serve to explain the principles of the invention.

FIG. 1 illustrates a heater having a screen according to the disclosed embodiments.

FIG. 2 illustrates a side view of a PTAC incorporating a heater and screen according to the disclosed embodiments.

FIG. 3 illustrates a side view of a heater and screen according to the disclosed embodiments.

FIGS. 4 and 5 illustrate screen configurations according to the disclosed embodiments.

FIG. 6 illustrates another screen configuration positioned on a heater according to the disclosed embodiments.

### DESCRIPTION OF THE PREFERRED EMBODIMENTS

One unit that is especially adapted for the invention is the packaged terminal air conditioner or PTAC. This unit has an electric heater located on the inlet side of a tangential fan. In these types of units, a fan draws air through an inlet grill and an air filter, through an air conditioner coil, and over heating elements of a heater, where the air is heated appropriately. The heated air moves into the blades of the tangential fan and finally the heated air is driven by the tangential fan through the outlet grill of the unit and back into the room. To occupants of the room, the vortexes created by the air heated by the electric heater traveling through the PTAC can often result in objectionable levels of noise.

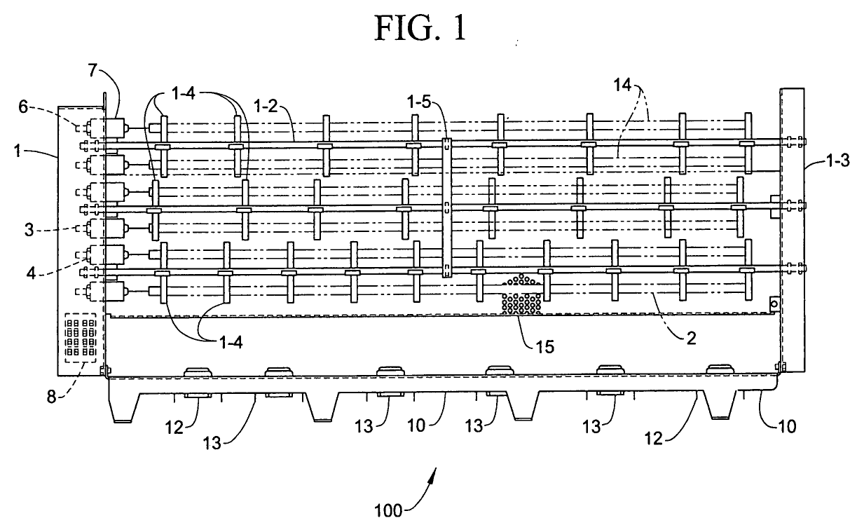

FIG. 1 depicts a heater 100 having a screen 15 to reduce vibration and noise within a PTAC or other applicable device. Heater 100 uses of a perforated metal plate or screen 15 of an appropriate size having holes, or perforations, of sufficient diameter and hole spacing that when appropriately located can reduce sounds, resulting from moving air, that emanate from the PTAC. Heater 100 is mounted in a position between the air conditioning coils and the tangential fan such that the air flows over the face of heater 100 in a direction generally perpendicular to a plane defined by the heater coils. The air moves through the heater coils, with at least a portion of the air passing through the perforated metal plate, which partially covers the face of heater 100.

The holes in the plate are of such a diameter and spacing as to allow sufficient airflow and allow proper operation of the PTAC. The plate is appropriately spaced so that electrical clearances are maintained between the heater coils and metal parts of the system. By appropriately selecting the position of the perforated metal plate in relation to the electric heater, vortexes created by the heated air are interrupted sufficiently so that no objectionable noise emanates from the PTAC. Further, the plate or screen may be mounted as a part of the open coil electric heater or may be installed as part of the unit, but separate from the heater.

Referring to FIG. 1, the components of the heater are typical in that the heater has a frame 1, a number of coils 2 and 14, male and female terminals 6 and 7, a top plate 10, thermostats 12 and 13 mounted in the top plate 10, an end plate 1-3, a stabilizer bar 1-5, a terminal plate 1-1, and a support bar 1-2, and clip and flat bushing assemblies (insulators) 1-4 for supporting the coils 2 and 14 on the heater frame 1.

Preferably, heater coils 2 are 1 kilowatt (kw) coils that provide heat while a current flows through them. Coils 14 may be 2 kw coils. Screws 3 and nuts 4 serve to mount terminals 6 and 7 to terminal plate 1-1. Label 8 may provide information regarding heater 100 to a user.

Screen 15, as shown, may cover all or some of coils 2 and 14. Screen 15 may be connected to frame 1 or top plate 10 to be in close proximity, but not touch, coils 2 and 14. Screen 15 includes holes having the same diameter and distance apart. The holes, preferably, are positioned to move air perpendicularly to the direction of coils 2 and 14. Further, screen 15 may cover all or part of coils 2 and 14 from a width perspective. In other words, screen 15 may not necessarily extend all the way across heater 100.

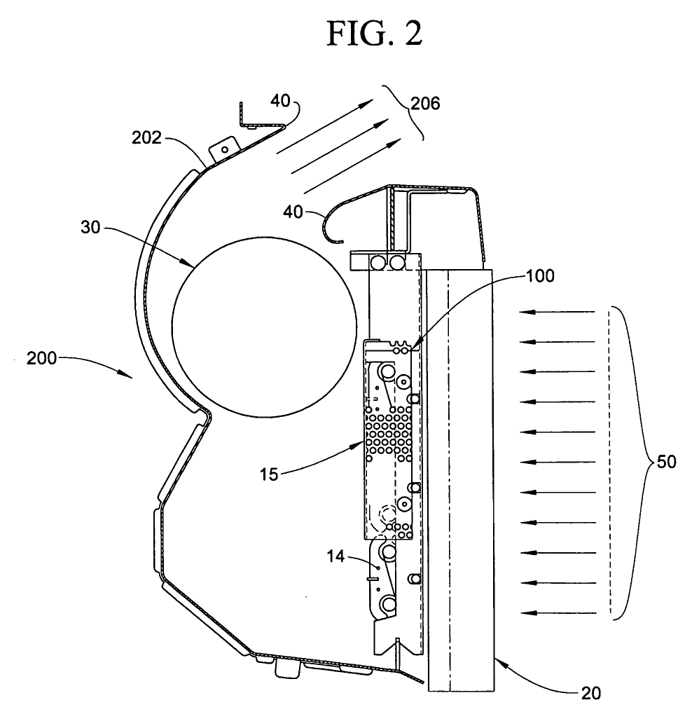

FIG. 2 depicts a side view of a schematic representation of a PTAC 200, showing heater 100, air conditioner evaporator 20, fan 30 and outlet aperture 40. PTAC 200 includes a housing 202 that encloses all the components listed above. Incoming air 50 flows through evaporator 20 and, in turn, through heater 100. A user may select which function PTAC 200 is to perform, either cooling or heating incoming air 50. Fan 30 takes the hot or cold air and blows it out outlet aperture 40 as outgoing air 206. Not shown is the grill and filter for incoming air 50.

FIG. 2 also illustrates the proximity of fan 30 to heater 100 and shows how close the two are. The close proximity makes it would be possible for the air exiting heater 100 and into fan 30 to cause a noise problem. In this embodiment, the effectiveness of screen 15 in reducing noise is attained by placing screen 15 over at least a portion of the heater 100, in essence covering the outflow of the heater for two of the three sets of the coils. It is believed that the proximity of the fan to the upper coils 2 and 14 and clip and flat bushings (insulators) 1-4 create the vortexes that can contribute to the generation of noise. Alternatively, heater 100 and fan 30 are not in close proximity, yet screen 15 may still be applied to heater 100.

The placement of screen 15 provides noise abatement, because when screen 15 is in place, the noise is reduced during operation of heater 100. Screen 15 directs air passing through heater 100 to a particular direction into fan 30 so as to reduce noise and vibration. Vortexes are avoided because the holes in screen 15 focus the air flow. Further, the noise is more prevalent upon start up of the heater, and this noise is effectively eliminated when using screen 15. In this embodiment, effective noise abatement is achieved without covering the entire heater flow area, so that screen 15 does not need to be positioned over the lowermost coil, shown as coil 14, to remedy the noise problem. This also saves cost by requiring less screen material.

While a PTAC unit is exemplified as one unit that the heater and screen combination can be employed, it is believed that screen 15 and heater 100 can be employed in units that would involve just a fan 30, where fan 30 and heater are positioned with respect to each other to create the noise disturbances discussed above. Also, while the PTAC is shown as one particular configuration that combines a heater with an air conditioner, the heater and screen combination could be employed with other air conditioning units where fan 30 and heater 100 would be positioned with respect to each other to create or contribute to the noise disturbances discussed above.

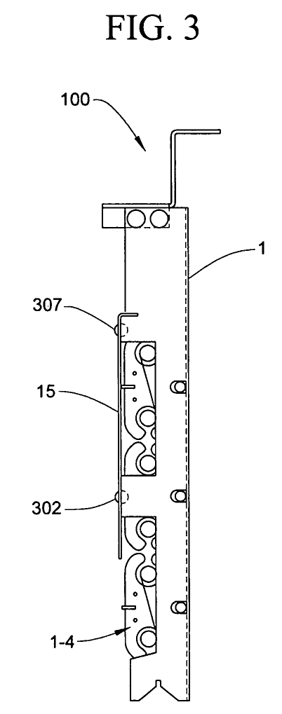

As noted above, screen 15 can be mounted to heater 100 using conventional attaching techniques, or be mounted to the unit that contains heater 100 but be separate from the heater. Another option would be to support screen 15 with both the unit and the heater, if necessary or desired for ease of mounting or the need to mount screen 15 in a particular location to accomplish the noise abatement. Referring to FIG. 3, screen 15 is shown covering a portion of heater 100. Screen 15 is attached to heater 100 by screws 302 to frame 1. The top portion of screen 15 may attach to end plate 1-3 of heater 100. Screen 15 extends partially down the height of heater 100 from top to bottom.

While screen 15 is shown covering a portion of heater 100 in FIG. 3, it may be that screen 15 should cover the entire heater opening that acts as a flow area for the heated air to travel downstream of heater 100. The positions of fan 30 and heater 100 may require that more of screen 15 be employed for noise abatement.

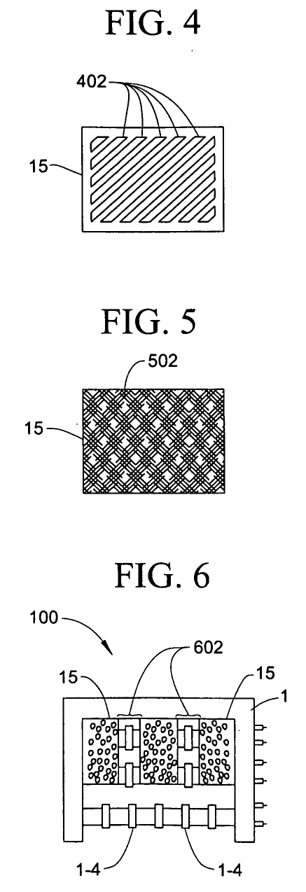

While screen 15 is shown as a metal perforated plate with circular openings, it can take other forms that would allow air to flow from the heater to the fan. Examples would include plates with different shaped openings, e.g., slots 402 as one example in FIG. 4 and wire mesh 502 as in FIG. 5, wherein the mesh would be made of wire material, with the wire spacing and diameter defining the flow through area of mesh 502.

In addition, referring to FIG. 6, a series of screens 15 could be employed, wherein screens 15 would be spaced apart from each other so that only a portion of heater 100 from side to side would be covered. Screens 15 are attached to frame 1 such that spaces 602 are formed. Further, coils 14 and insulators 1-4 are exposed as well. Within all these configurations, one should avoid positioning screen or screens 15 near coils 2 and 14 of heater 100 to avoid contact that may cause disruption of the heating operation.

The perforated screen shown in FIG. 1 has an opening area of 51% of the screen. However, it should be understood this actual percentage is only a preferred target and others could be used, for example a percentage in the range of 20-95%, with a more preferred range of 40-60%. In fact, any opening percentage could be employed as long as it is effective to reduce the noise associated with the heater operation and the screen and/or screen openings are designed such that air flow through the heater is not disrupted to the point that the pressure drop caused by the screen affects the unit operation. The screen 15 can be made of any material that would withstand the operating conditions of heater 100. An exemplary material is a stainless steel plate but other materials as would be known in the art could be employed.

While a single screen is shown, a number of screens could be combined to achieve the desired noise abatement. Moreover, screens having the same configuration or screens with different configurations could be combined together. For example, screen 15 may include holes having a diameter on an upper portion and wire mesh on a lower portion. As shown in FIG. 6, some parts of coils 14 and insulators 1-4 may be left uncovered due to design constraints.

While FIG. 3 shows screen 15 positioned between fan 30 and heater 100, with fan 30 downstream of heater 100, a particular heating unit or heating and air conditioning unit may have heater 100 downstream of fan 30, and noise could be created in this arrangement as well. In such an arrangement, screen 15 could still be positioned upstream of heater 100 and between heater 100 and fan 30 to disrupt any vortexes that may be generated due to the proximity of heater 100 to fan 30.

As such, an invention has been disclosed in terms of preferred embodiments thereof, which fulfills each and every one of the objects of the invention as set forth above, and provides an improved heating or heating and air conditioning unit for conditioning air for an enclosed space, an improved heater design, and a method of use.

Of course, various changes, modifications and alterations from the teachings of the present invention may be contemplated by those skilled in the art without departing from the intended spirit and scope thereof. It is intended that the present invention only be limited by the terms of the appended claims.

What is claimed is:

1. An open coil electrical resistance heater comprising:
a frame;
at least one electrical resistance wire coil;
a plurality of insulators connecting the at least one electrical resistance wire coil to the frame, wherein the plurality of insulators and at least one electrical resistance wire coil forms an air flow area to expel air from the heater; and
at least one screen positioned adjacent the at least one electrical resistance wire coil to cover the air flow area.

2. The heater of claim 1, wherein the heater is used with a packaged terminal air conditioning unit.

3. The heater of claim 1, wherein the at least one electrical resistance wire coil includes a plurality of electrical resistance wire coils.

4. The heater of claim 3, wherein the at least one screen is positioned to cover the air flow area corresponding to at least some of the plurality of electrical resistance wire coils.

5. The heater of claim 4, wherein the plurality of electrical resistance wire coils includes three electrical resistance wire coils, and the at least one screen is positioned to cover two of the three electrical resistance wire coils.

6. The heater of claim 1, wherein the at least one screen is a plate with perforations, wherein an amount of the perforations with respect to an area of the plate ranges from about 40% to about 95%.

7. The heater of claim 6, wherein the amount of the perforations with respect to the area of the plate ranges from about 40% to about 60%.

8. A method of heating a space using a heating unit or a heating and air conditioning unit, the method comprising:
drawing air through an open coil electrical resistance heater by a fan, where the open coil electrical resistance heater includes at least one electrical resistance wire coil supported on a frame by insulators;
energizing the heater to heat the air; and
partially disrupting the air from the heater with at least one screen positioned between the fan and the at least one electrical resistance wire coil.

9. The method of claim 8, wherein the unit is a packaged terminal air conditioner.

10. The method of claim 8, wherein the at least one electrical resistance wire includes a plurality of electrical resistance wire coils.

11. The method of claim 10, wherein the at least one screen is positioned to cover a portion of an air flow area corresponding to at least some of the plurality of electrical resistance wire coils.

12. The method of claim 11, wherein the plurality of electrical resistance wire coils has three electrical resistance wire coils, and the at least one screen is positioned to cover two of the three electrical resistance wire coils.

13. The method of claim 8, wherein the at least one screen is a plate with perforations, wherein an amount of the perforations with respect to an area of the plate ranges from about 20% to about 95%.

14. The method of claim 8, further comprising directing the air towards the fan using the screen.

15. A heater unit or a heating and air conditioning unit comprising:
an open coil electrical resistance heater, wherein the heater has a frame;
at least one electrical resistance wire coil;
a plurality of insulators connecting the at least one resistance wire coil to the frame, wherein the insulators and the at least one electrical resistance wire coil form an air flow area to expel air from the heater for heating a space; and
at least one screen positioned adjacent the at least one electrical resistance wire coil to cover the air flow area.

16. The unit of claim 15, wherein the unit is a packaged terminal air conditioner.

17. The unit of claim 15, wherein the at least one screen is supported by the heater, or the unit, or a combination of both.

18. The heater of claim 1, wherein two or more screens are combined to comprise the at least one screen.

19. The method of claim 8, wherein two or more screens are positioned between the fan and the heater to partially disrupt air.

20. The unit of claim 15, wherein two or more screens are combined.
